(19) United States
(12) Patent Application Publication
(10) Pub. No.: US 2005/0012362 A1
(43) Pub. Date: Jan. 20, 2005

(54) Longitudinal girder as part of a load bearing structure of a motor vehicle

(76) Inventors: Lothar Patberg, Aachen (DE); Dariush Philipp, Krefeld (DE)

Correspondence Address: PROSKAUER ROSE LLP;PATENT DEPARTMENT, 1585 BROADWAY, NEW YORK, NY, 10036-8299, US

(21) Appl. No.: 10/492,883

(22) PCT Filed: Oct. 23, 2002
(86) PCT No.: PCT/EP02/11821

(30) Foreign Application Priority Data
Nov. 7, 2001 (DE) 101 54 215.1

(51) Int. Cl. B62D 25/20

(52) U.S. Cl. 296/203.01

(57) ABSTRACT

The invention relates to a longitudinal girder used as part of a load bearing structure of a motor vehicle. In order to optimize the flexural strength, load bearing capacity and crash behavior of a longitudinal girder within a given construction area, the inventive longitudinal girder consists of two hollow profiles (1a, 1b, 2a, 2b) which are disposed at a height/width ratio of approximately 1 and which are connected to each other on both ends thereof (5, 6, 9a, 9b, 10a, 10b) in a dimensionally stable manner.

The invention relates to a longitudinal member as part of a supporting structure of a vehicle, with said longitudinal member's width/height ratio being a₀/b₀<1, wherein said longitudinal member comprises at least two hollow sections which extend essentially parallel to each other.

Longitudinal members which have been constructed according to today's state of the art have already been optimize with respect to achieving great weight savings while at the same time achieving maximum rigidity. In other words, it is probably no longer possible to realise any weight savings potential purely by reducing the sheet metal thickness or purely by reducing the cross-sectional area of the profile of the member. Any further reduction in sheet metal thickness would result in inadequate rigidity, in particular in relation to resistance to bending or resistance to buckling, of the longitudinal member.

In order to nevertheless achieve a reduction in weight by reducing the sheet metal thickness, a well-known design measure consists of using a higher-strength material which provides still adequate mechanical strength even at reduced sheet metal thickness so as to maintain adequate strength of the longitudinal member rather than letting the strength drop to below a specified minimum. The known measure of producing the section of the longitudinal member from a high-strength steel material and of reducing the sheet metal thickness accordingly would at first seem to be a possible solution.

However, the use of high-strength steel materials is associated with new problems in relation to the crash behaviour of the supporting structure. The force F, which in the case of a crash is transferred to the passenger compartment, is calculated according to the equation F=σ×A, with a designating the apparent limit of elasticity of the material, and with A=U×t applying, i.e. A is the cross-sectional area of the material of the section of the longitudinal member with a circumference U and a sheet metal thickness t. Since in the case of materials comprising high-strength steel the value σ clearly exceeds the value of materials in conventional longitudinal members, without a reduction in the sheet metal thickness t, the extent of force F transferred to the passenger compartment in the case of a crash is clearly unacceptably great (endangering the passengers). On the other hand, if the sheet metal thickness t were to be reduced in order to reduce the force F which would be transferred in the case of a crash, this would result in a reduction of resistance to bending, thus increasing the danger of a so-called bending collapse. The term “bending collapse” refers to failure of the longitudinal member as a result of buckling or collapsing.

The force F which would be transferred in the case of a crash could also be achieved by reducing the circumference U of the section of the longitudinal member, namely by shortening its edges, but such a solution cannot be considered since it would result in an excessive reduction in the rigidity of the longitudinal member, which would lead to a reduction in its support function. A reduction in the edge lengths a₀ and b₀ also increases the danger of a bending collapse, since the section would become narrower.

Therefore, for the reasons mentioned above, considering that the force transferred to the passenger compartment has to be kept to a level sustainable by the passengers, it is not possible to achieve any significant weight reduction in relation to the longitudinal member by reducing the edge length of the section and/or by reducing the sheet metal thickness.

There is an additional reason why the ratio of edge lengths a₀/b₀ cannot be reduced any further, namely that there are so-called stability criteria, (Schriever, T: “Zur nichtlinearen FE-Analyse des Verformungsverhaltens von Fahrzeuglängsträgern mit gezielt eingebrachten geometrischen Imperfektionen” [Non-linear FE analysis of the deformation behaviour of longitudinal members in vehicles, which members comprise purposefully-created geometric imperfections]; Institut für Kraftfahrwesen Aachen [institute of automotive engineering] RWTH Aachen, Aachen 1990)) in relation to the longitudinal member folding during deformation as a result of a crash, which stability criteria have to be met. A first stability criterion, designated “folding compatibility” demands that, during deformation of the longitudinal member as a result of a crash, the long sides b₀ of the section must be able to fold without any obstruction or hindrance because only in this way can the maximum possible quantity of energy be absorbed and converted to deformation energy. It is therefore not permissible for the interior surfaces of the section to touch each other along their longitudinal edges b₀ during folding, as this would impede unrestricted fold formation. For this reason, the longitudinal ratio a₀/b₀ must not be below a lower limiting value.

So-called “compactness” is a second stability criterion. A stable and regular folding process as a result of crash deformation depends on the ratio of sheet metal thickness t to the long side b₀ of the section of the longitudinal member. This ratio t/b₀ must therefore not drop below a specific critical value. The precise definition of this critical value depends among other factors on the type and quality or grade of the material of said longitudinal member. It is thus evident that the stability criterion of “compactness”, which the expert endeavours to meet in the interests of a stable and regular folding process in the case of a crash, prevents the expert from further reducing the sheet metal thickness t in an attempt to save weight.

The stability criterion of “folding compatibility” is also not being met in a known longitudinal member of the type mentioned in the introduction (U.S. Pat. No. 4,986,597). In this member, two hollow sections are connected with flanges along their entire length, in that the hollow sections with the flanges form a further hollow section between each other. Such a longitudinal member is a functional structural unit, i.e. its two hollow sections, due to their connection along their entire length, are exposed to loads as a unit, in particular in relation to bending and torsional loads. In this known longitudinal member, the ratios of width to height of the individual hollow sections regularly exceed 1, sometimes even by a significant factor. Such a longitudinal member therefore is associated with an inherent risk of free fold formation being impeded in the case of a crash, in that the folds of facing sides abut against each other.

Apart from such longitudinal members whose hollow sections constitute a functional structural unit, a longitudinal member structure is known which comprises a double longitudinal member plane, each made from compact individual sections arranged so as to be spaced apart from each other (Stahl und Eisen [steel and iron] 121 (2001), no. 7, pages 36 and 37). In such a structure of a longitudinal member, in the case of a frontal crash and also during simple bending loads, the individual sections, which are hollow sections, are exposed to loads independently of each other, because, in contrast to the situation existing in the context of the above-mentioned longitudinal member, no alternating support can be provided because the individual sections are not interconnected. This means that each individual section has to be designed to withstand the maximum load that can be exerted. This is usually implemented by means of increased wall thickness of the individual sections. This known longitudinal member with a double plane is therefore different from a supporting element whose hollow sections constitute a functional structural unit.

It is thus the object of the invention to provide a longitudinal member for vehicles, in a light-weight design, which has the following characteristics:
a) The weight of the longitudinal member is less than that of longitudinal members made according to the conventional design principle.
b) The rigidity of the longitudinal member, in particular its resistance to bending, is at least equal to that in longitudinal members made according to the conventional design principle.
c) The longitudinal member's energy absorption capacity in the case of a crash exceeds that of longitudinal members made according to the conventional design principle.
d) The longitudinal member does not take up any more design space than longitudinal members made according to the conventional design principle.

The term “longitudinal member made according to the conventional design principle” refers to a longitudinal member which comprises a closed section of a height b₀ which clearly exceeds its width a₀, as a rule by a factor of 2-3. The closed profile can comprise two section halves connected to each other by joining-flanges (so-called monocoque construction), or it can be a closed section without a flange. In any case, the geometric condition of the “height b₀ exceeding the width a₀” is a characteristic condition. Conventional longitudinal members are of such geometric shape because of the excellent resistance to bending which such a section provides around an axis which is perpendicular to its longitudinal axis.

According to the invention, this object is met by a longitudinal member of the type mentioned in the introduction, in which longitudinal member the hollow sections: have a width/height ratio of a_{1,2}/b_{1,2} 1; are arranged so as to be spaced apart from each other with a free space in-between; and are interconnected at both ends so as to be dimensionally stable. In particular, the overall height of the longitudinal member should very substantially exceed the height of each hollow section.

With external dimensions which are identical to those of a longitudinal member made according to the conventional design principle, the longitudinal member according to the invention has a resistance to bending which is at least equal to that of the member made according to the conventional design principle, so that said longitudinal member according to the invention can fully meet the support function. However, it also meets the stability criteria of “folding compatibility” and “compactness” in that each individual profile meets these criteria. In the case of a crash all individual sections can fold without any hindrance due to this dimensioning. This ensures maximum energy absorption in the case of a crash. Purely based on the new geometric design and dimensioning of the longitudinal member, a weight saving potential of 20% results.

Plates and/or sheet metal pieces, installed at the ends and/or laterally, provide dimensionally stable connections between the hollow sections. However, the dimensionally stable connections can also be provided by other adjoining components.

Below, the invention is explained in more detail with reference to a drawing which shows the following:

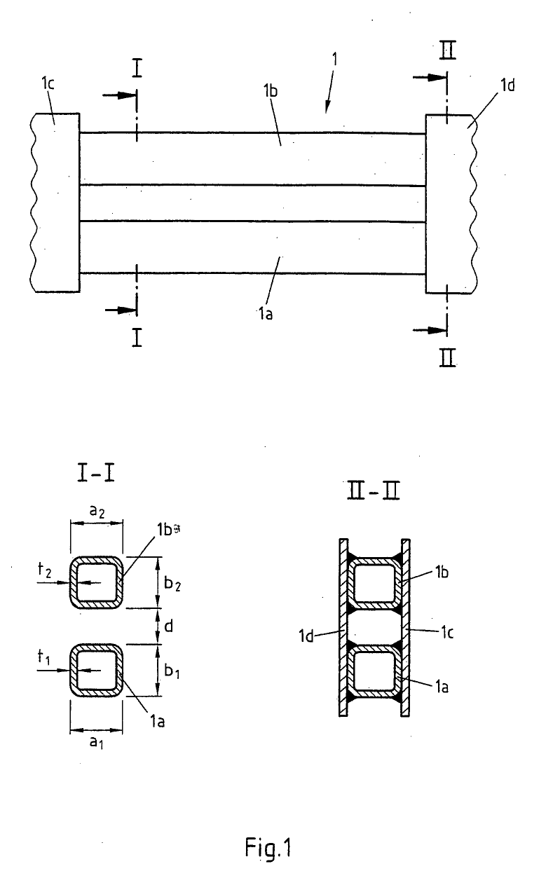

FIG. 1 a lateral diagrammatic view as well as the associated cross-sectional view of a longitudinal member of a supporting structure of a vehicle, comprising two hollow sections which constitute a functional structural unit;

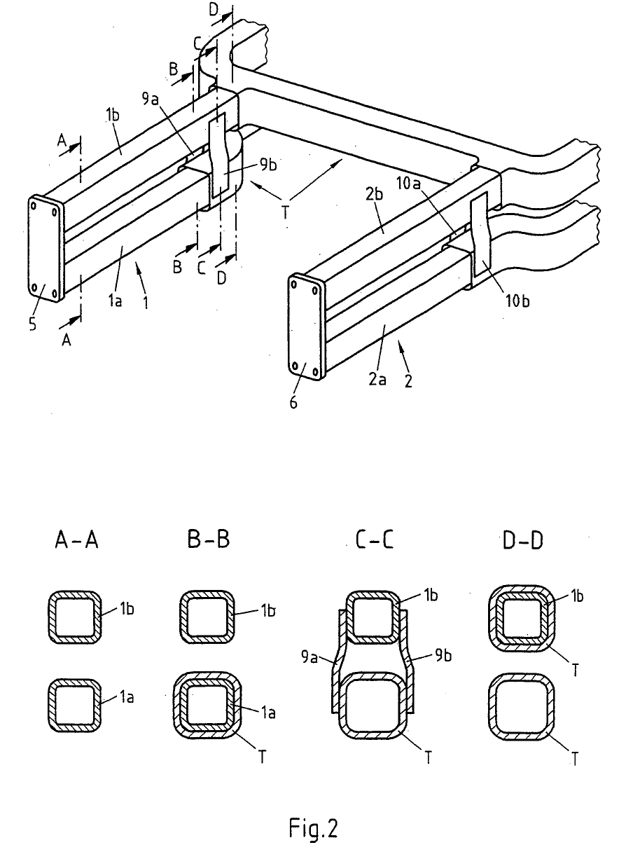

FIG. 2 a perspective view, including several associated cross-sectional views, of two longitudinal members according to FIG. 1, connected to a passenger compartment, as part of a supporting structure of a vehicle in space-frame design;

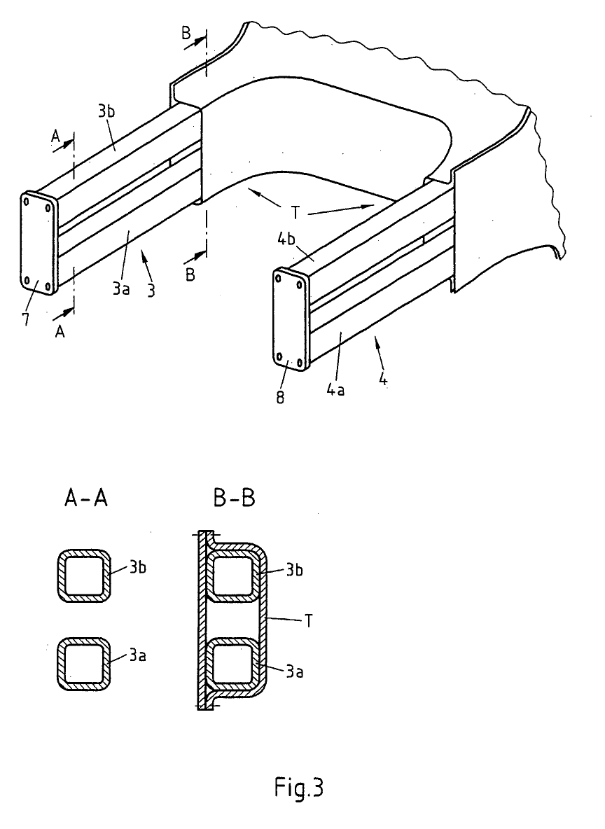

FIG. 3 a perspective view, including several associated cross-sectional views, of two longitudinal members according to FIG. 1, connected to a passenger compartment, as part of a supporting structure of a vehicle in space-frame design, in an embodiment which differs from that of FIG. 2; and

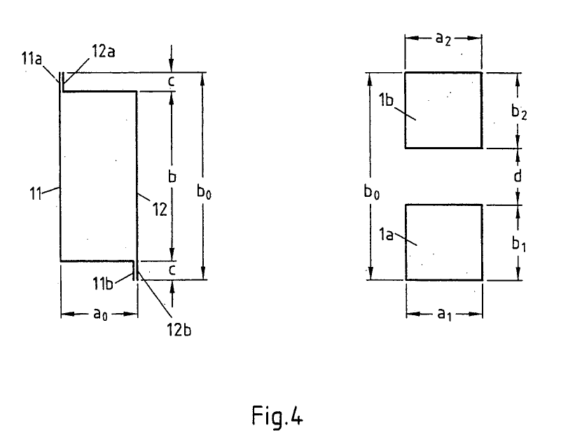

FIG. 4 a diagrammatic cross-sectional view of a comparison between a longitudinal member according to the invention and a longitudinal member made according to the conventional design principle.

The longitudinal member 1, 2, 3, 4 according to the invention forms part of a supporting structure T of a vehicle in space-frame design, with parts of the passenger compartment also being shown in FIGS. 2 and 3.

Each longitudinal member 1, 2, 3, 4 comprises two hollow sections 1a, 1b, 2a, 2b, 3a, 3b, 4a, 4b made of sheet steel, which extend parallel in relation to each other and are spaced apart from each other. At their ends, both hollow sections 1a, 1b, 2a, 2b, 3a, 3b, 4a, 4b are interconnected so as to be dimensionally stable, so that they form a functional unit. FIG. 4 diagrammatically shows these dimensionally stable connections as connectors 1c, 1d. They can be of various designs, in particular they can be end plates/sheets or lateral plates/sheets. It is also possible for the adjacent support structure T to be included in the dimensionally stable connections, as shown in FIGS. 2 and 3. All the conventional techniques can be considered as connection techniques, for example welded or soldered connections, screw connections, adhesive connections or rivet connections. The decisive point is that any such connections interconnect the hollow sections 2, 3 in a dimensionally stable manner.

The front ends of the hollow sections 1a, 1b, 2a, 2b, 3a, 3b, 4a, 4b, as shown in both embodiments of FIGS. 2 and 3, are connected by way of plates/sheets 5, 6, 7, 8 arranged at the ends. In the embodiment shown in FIG. 2, the rear ends are integrally connected in an overlapping manner to hollow sections of the supporting structure T of the passenger compartment, in particular by way of soldered connections on the one hand, and are interconnected so as to be dimensionally stable by way of lateral plates/sheets 9a, 9b, 10a, 10b on the other hand. In the embodiment according to FIG. 3, the rear ends are interconnected in an overlapping manner to the rigid hollow section of the supporting structure T of the passenger compartment, and furthermore to each other so as to be dimensionally stable.

FIG. 4 shows a comparison between a longitudinal member comprising a single hollow section, made according to the conventional design principle, and a longitudinal member according to the invention, which latter member comprises two hollow sections 1a, 1b which form a functional structural unit. The conventional longitudinal member has been made in stressed-skin construction, i.e. its two shells 11, 12 are interconnected by way of flanges 11a, 11b, 12a, 12b. As the comparison shows, the external dimensions of the two longitudinal members are identical, with the width a₀=a₁=a₂. The overall height of the conventional longitudinal member is b₀=b+2c. In the longitudinal member according to the invention, the overall height is identical, being b₀=b₂+b₂+d, with d=height of the free space between the two hollow sections 1a, 1b. Preferably, b₁ b₂ and d=0.5 b₁ to 1.0 b₁. As far as the height/width ratio is concerned, a₀/b₀<1 applies, in particular a₀/b₀<<1, wherein “<<” denotes a factor of at least “2”, as a rule of between “2” and “3”. At the end of the description, two comparisons for specific dimensioning have been provided in relation to these longitudinal members. Example 1 shows the higher-strength steel DP-K 34/60 with an elongation limit R_{p0.2}=340 N/mm² as a material for the longitudinal member according to the invention, while the comparison longitudinal member made according to the conventional design principle was made from ZStE 300 (elongation limit R_{p0.2}=340 N/mm². When compared to the conventional longitudinal member, the wall thickness of the individual profiles was reduced by approx. 25.93% from 1.35 mm to 1.00 mm. The free cut edge A relevant for load transmission through the longitudinal member (in example 1 referred to as “cross-sectional area”) in the longitudinal member according to the invention is only A=496 mm², while in the conventional longitudinal member it is A=623.7 mm². Since the mass of the longitudinal member is proportional to its free cut edge (mass=p×L×A, with p×L=const.), a comparison of these values determines that the longitudinal member according to the invention has only 79.5% of the mass of the conventional longitudinal member, and that thus weight savings of 20.5% were achieved.

The values relating to the force Fₘ show that the quantity of energy absorbed in the case of a crash is clearly greater in the longitudinal member according to the invention than in the conventional longitudinal member. This comparison can be made using the values for Fₘ, because the absorbed energy is proportional to the force Fₘ, which is calculated from the equation Fₘ=σₘ×A, with σₘ denoting the average tension effective in the longitudinal member

$${σ}_{m} = {[ \frac{{k}_{m} \cdot E \cdot {( \frac{t}{b} )}^{2}}{( 1 - {v}^{2} ) \cdot β \cdot {R}_{p0 , 2}} ]}^{M} \cdot {R}_{p0 , 2}$$

(Source: Schriever, T. see above).

On the one hand σₘ depends on the material (higher-strength steels have significantly better σₘ values than conventional longitudinal member steels), on the other hand σₘ also depends on the geometric shape of the longitudinal member or of the individual profiles.

It should be pointed out that the invention exclusively relates to the geometric shape of the new longitudinal member. However, it is also possible to achieve further-reaching weight savings by way of selecting the strength of the material, as has been explained in example 1 above. However, clear weight savings can also be achieved simply by selecting the same material as used in the state of the art. We refer to example 2 in this context.

### EXAMPLES

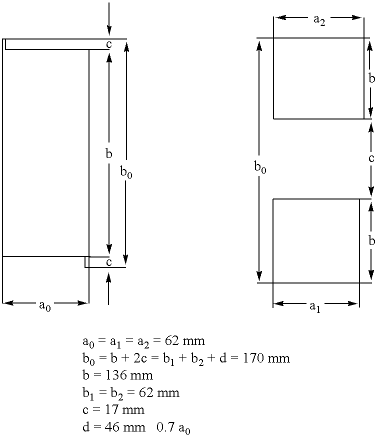

### Example 1

Example 1

| ZStE 300, R_{p0.2} = 300 | | DP-K 34/60, R_{p0.2} = 300 |
|---|---|---|
| N/mm² | | N/mm² |
| T = 1.35 mm | Sheet metal thickness | T = 1.00 mm |
| A = U x t = 462 mm x | Cross-sectional area | A = 2 × 248 mm × 1.00 |
| 1.35 mm = 623.7 mm² | as a dimension for the | mm = 496.00 mm² |
| | mass | |
| m − A = 100% | Mass | m = 79.5% |
| σₘ = 58.1 N/mm² | Average tension | σₘ = 83.3 N/mm² |
| Fₘ = 36.2 kN | Force − absorbed | Fₘ = 41.3 kN |
| | energy | |

### Example 2

Example 1

| ZStE 300, R_{p0.2} = 300 | | ZStE 300, R_{p0.2} = 300 N/ |
|---|---|---|
| N/mm² | | mm² |
| T = 1.35 mm | Sheet metal thickness | T = 1.00 mm |
| A = U x t = 462 mm x | Cross-sectional area | A = 2 × 248 mm × 1.00 |
| 1.35 mm = 623.7 mm² | as a dimension for the | mm = 496.00 mm² |
| | mass | |
| m − A = 100% | Mass | m = 79.5% |
| σₘ = 58.1 N/mm² | Average tension | σₘ = 77.6 N/mm² |
| Fₘ = 36.2 kN | Force − absorbed | Fₘ = 38.5 kN |
| | energy | |

1-3. (Cancelled).

4. A longitudinal member as part of a supporting structure of a vehicle, with said longitudinal member being arranged in front of and behind the passenger compartment of the vehicle, and with said longitudinal member's width/height ratio being a₀/b₀<1, wherein said longitudinal member comprises at least two hollow sections which extend essentially parallel to each other, wherein the hollow sections have a width/height ration of a_{1,2}/b_{1,2}˜1; are arranged so as to be spaced apart from each other with a free space in-between; and are interconnected at both ends so as to be dimensionally stable.

5. The longitudinal member of claim 4, wherein the longitudinal member is arranged in front or behind the passenger compartment of the vehicle.

6. The longitudinal member of claim 4, wherein the overall height b₀ of the longitudinal member exceeds by a multiple factor the height b_{1,2} of each hollow section.

7. The longitudinal member of claim 4, wherein plates, sheet metal pieces, or combination thereof installed at the ends, laterally, or combination thereof provide a dimensionally stable connection between the hollow sections.
